(19) United States
(12) Patent Application Publication
(10) Pub. No.: US 2007/0227203 A1
(43) Pub. Date: Oct. 4, 2007

(54) Device for Actuating an Electrical or Mechanical Closure Mechanism on a Vehicle Door and/or Shutter

(76) Inventor: Franz-Josef Weber, Erkrath (DE)

Correspondence Address: FRIEDRICH KUEFFNER, 317 MADISON AVENUE, SUITE 910, NEW YORK, NY, 10017, US

(21) Appl. No.: 11/578,878

(22) PCT Filed: Apr. 5, 2005
(86) PCT No.: PCT/EP05/03553

§ 371 Date: Oct. 20, 2006

(30) Foreign Application Priority Data
Apr. 22, 2004 (DE) 10 2004 019 571.4

(51) Int. Cl. E05B 65/12

(52) U.S. Cl. 70/91

(57) ABSTRACT

The invention concerns a device for actuating an electrical or mechanical closure mechanism on a vehicle door and/or shutter, involving the use of a sensor (40) which responds to nearness or touch. For the device to identify unequivocally whether the sensor control (40) is actually performed by a human hand or inadvertently by an object, an auxiliary sensor (50) which, in the form of a detection element has a piezoelectric element (51), is arranged at the main sensor (40) contact zone. At least the auxiliary sensor (50) is covered with a flexible wall (28) which, upon contact, exerts a pressure on the piezoelectric element (51) and forms a common actuating location (28). When said actuating zone is contacted, the main sensor and the auxiliary sensor (40, 50) emit separate signals which however are evaluated in the same way (42). When the result of the evaluation is positive, an output signal is emitted, said signal shifting the lock to its locking position. The actuating of the handle (20) is then ineffective.

The invention pertains to an arrangement of the type indicated in the introductory clause of Claim 1. The sensor of the arrangement responds to approach or to contact.

DE 196 17 038 C2 describes a closing arrangement for a vehicle with a capacitive sensor, which responds only when an authorized person approaches it. The authorized person carries an identification transmitter (ID transmitter), which works together with an identification receiver (ID receiver) in the vehicle. When the hand approaches the sensor, the capacitance changes, and this is detected by the sensor. If the person in question is authorized, data are communicated between the ID transmitter and the ID receiver. The actual data received are compared with nominal data contained in a memory unit. If the comparison is successful, the actuation function of the closing device is switched to an active state even before the handle of the closing device is in fact actuated by the authorized person. The person who actuates the handle notices nothing of these communications or of this data comparison. The door or hatch is opened and closed without any delay.

A door closing system for motor vehicles with a sensor in the door handle, which generates a first signal when the handle is contacted and a second signal when the handle is let go, is known from WO 01/40,606 A1. The two signals are interpreted as the beginning and the end of the actuation of the handle.

DE 102 40 828 A1 describes an arrangement of the type indicated in the introductory clause of Claim 1. The two sensors are a certain distance apart in different areas of a door handle and consist either of capacitive sensors or of pressure-sensitive or piezoelectric switches. Allocating two areas in the handle for the actuation of the sensors requires twice as much room, which is then no longer available for the installation of other important components. It cannot be excluded that both of the sensors operating on the same principle will respond to foreign objects such as falling leaves, rain, or snow and cause the state of the lock to be switched when this is not wanted.

So that no unnecessary, energy-consuming communication takes place, a sensor should not respond to the approach of, or to contact by, any object at all, but rather only to the approach of, or to contact by, a human hand. It is undesirable for any random external influence such as rain, snow, ice, or leaves to result in the actuation of the device. For this reason, a capacitive sensor in DE 196 20 059 A1 also determines the speed at which the capacitance changes when an object approaches or makes contact. In this known arrangement, use is made of the circumstance that the change in capacitance per unit time is greater upon the approach of a human hand to the sensor than upon the approach of foreign objects. When the change in capacitance per unit time is measured, the actuation function of the closing device is switched to an active state only if the change in capacitance over time exceeds a certain limit value. This method cannot be used in all cases, however.

The invention is based on the task of developing a space-saving, simple arrangement of the type indicated in the introductory clause of Claim 1, which differentiates clearly between actuation of the sensor by a human hand and actuation by foreign objects and which switches the state of the lock only in the former case. This is achieved according to the invention by the measures cited in Claim 1, to which the following special meaning attaches.

The inventive sensor arrangement saves space, because the main and auxiliary sensors are arranged on top of each other and require only a single actuating point. This common actuating point is designed as a resilient wall, so that, when actuation occurs, pressure is exerted on the piezoelectric element of the auxiliary sensor and a capacitive effect is produced on the main sensor. Because the main and auxiliary sensors work on the basis of two different principles, one capacitive, the other piezoelectric, double operational reliability is achieved when the results of the two signals generated in their different ways agree. There is no danger that the closing device could be actuated mistakenly in the invention.

So that the lock can be switched from one state to another, it is not enough for the main sensor to detect the approach of an object and to transmit a signal. It is also necessary for the common resilient actuating point to be contacted simultaneously or at least within a certain time window. This contact must be strong enough that sufficient pressure is exerted on the piezoelectric element to cause the auxiliary sensor to transmit its own signal. Although the signals of the capacitive main sensor and those of the piezoelectric auxiliary sensor are generated in different ways, they can be combined electronically into a common output signal, which is sent to a control unit in the vehicle. If the output signal is based on a successful evaluation of the two signals, the control unit switches the state of the lock.

Additional measures and advantages of the invention can be derived from the subclaims, from the following description, and from the drawings. The drawings illustrate the invention schematically on the basis of an exemplary embodiment:

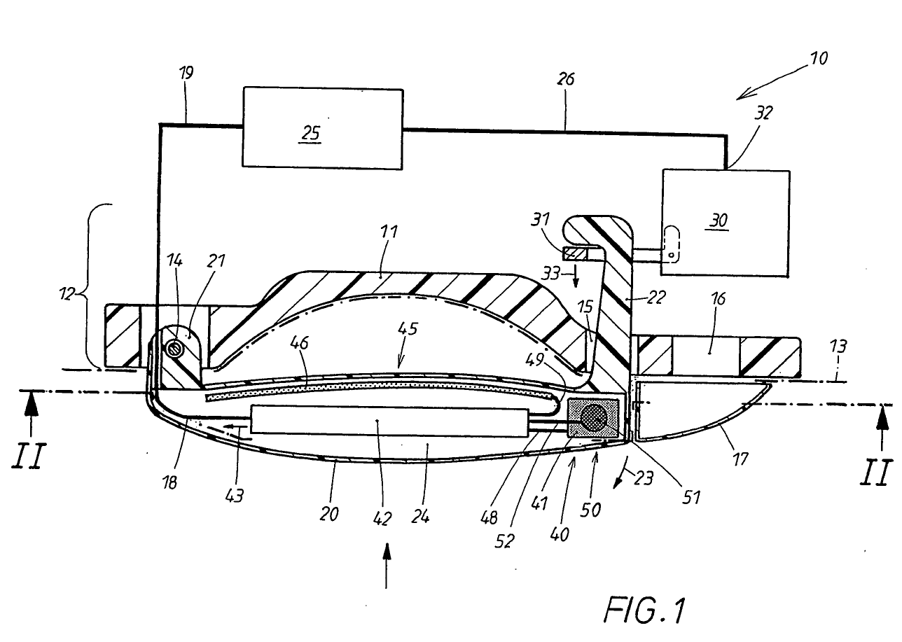

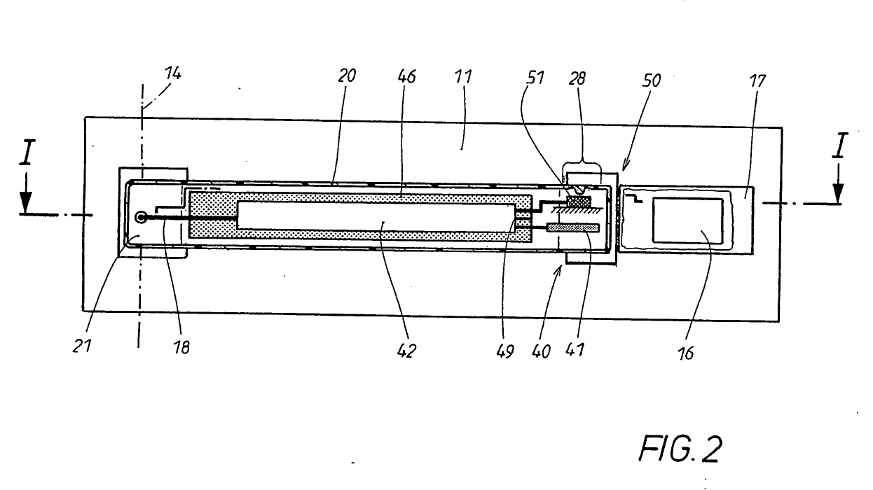

FIG. 1 shows an essentially horizontal longitudinal section through an external door handle of a vehicle in which the inventive arrangement is realized; the viewing direction is indicated by the cross-sectional line I-I of FIG. 2;

FIG. 2 shows a vertical longitudinal section through the external door handle shown in FIG. 1 along the cross-sectional line II-II in that figure; and

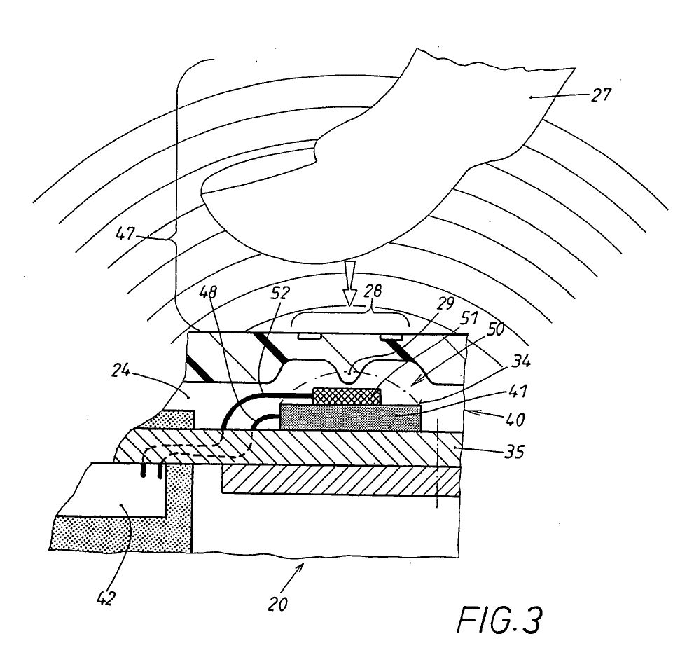

FIG. 3 shows, on a much enlarged scale, a part of the vertical longitudinal section of FIG. 2, revealing more of the design details.

The closing device 10 used in the arrangement comprises a bracket 11, which is mounted in the interior of a door 12 of a vehicle (not shown). Only the exterior panel 13 of the door 12 is shown in dash-dot line.

The closing device 10 also includes a handle 20. One end 21 of the handle 20 is supported pivotably in the bracket 11. The axis 14 of the pivot bearing is essentially vertical, for which reason the handle 20 is a so-called “pull-handle”. The other end 22 of the handle 20 has an extension with a hook at the end. The extension passes through an opening 15 in the exterior door panel 13 and in the bracket 11. The hooked end of the extension grips a mechanical input element 31 on a lock 30 installed in the door 12.

The lock 30 normally holds the door 12 in its closed position. The lock 30 can be in either one of two different operating positions, as desired, namely, a locked position and an unlocked position. When the handle 20 is pivoted in the direction of the arrow 23 in FIG. 1, the extension 22 carries the lock element 31 along with it in the direction of the arrow 33 in FIG. 1. When the lock 30 is in the unlocked position, this actuation 23 of the handle 20 is functionally effective. The lock 30 thus releases the door, and the door 12 can be opened. If, however, the lock 30 is in the locked position, the actuation 23 is not functionally effective; the lock element 31 is carried along in an inactive manner, and the lock 30 thus does not release the door. In spite of the actuation 23, the lock 30 remains locked in its closed position.

In an emergency, the lock 30 can be switched from one state to another mechanically, e.g., by the use of a lock cylinder. Although this is not shown in detail, another opening 16 in the bracket 11 and in the exterior door panel 13 can be seen, in which a lock cylinder of this type could be installed. The lock cylinder can be actuated by an emergency key. The front end of the lock cylinder, where the key can be inserted and removed, can be integrated into a cover piece 17, which is attached to the bracket 11 and which is designed so that it is flush with the handle 20.

In the normal case, the lock 30 is switched between the unlocked position and the locked position by electrical means. For this purpose, the lock 30 has an electrical input 32. The three sensors 40, 45, and 50, which carry out functions to be described in greater detail later, are the initiators of this electrical switching of the lock 30. In the present case, all three sensors 40, 45, 50 are installed in the interior 24 of the handle 20. Electronic components 42, which are used for operations, for control, and/or for evaluation of the signals coming from the three sensors 40, 45, 50 are also installed in the interior 24 of the handle.

Two of these sensors 40, 45 in the present case act on the basis of capacitance. The electrodes 41, 46 of these sensors are indicated in the figures by different types of shading. The electrodes 41, 46 cooperate with the body of the vehicle and/or the environment to build up an electrical field. A field 47 of the capacitive sensor 40 is suggested in FIG. 3 by field lines. When an object such as a finger 27 shown by way of example in FIG. 3 arrives in one of the electrical fields generated by the electrodes 41, 46, the capacitance between the electrodes 41, 46 and the vehicle or its environment changes. This is registered and evaluated by the associated electrical evaluation units 42 in different ways, which will be described in greater detail later.

If the evaluation is successful, the associated components 42 transmit an output signal 43, illustrated by an arrow in FIG. 1, which is sent over an electric line 18 in the area of the handle 20 and over an extension of that line in the form of an electric cable 19 in the door 12 to a control unit 25. This can be a central control unit 25, which acts on the various locks 30 in the various doors and hatches of the vehicle by way of numerous electrical connections 26 between it and the locks. The electrical connection 26 is connected to the previously mentioned electrical input 32 of the lock 30 in question. Instead of an electrical connection 26, the control unit 25 could also act mechanically on a second input element (not shown) of the lock 30.

The two capacitive sensors 40, 45 act independently of each other and work in ways which differ from each other. One capacitive sensor 45 is set to a very high sensitivity and acts in the known manner upon the approach of an object, especially of an authorized person. This sensor 45 is used to release a locked lock 30 and thus, as previously described, to make it possible to actuate 23 the handle 20 successfully. This takes place, however, only if the following additional condition is satisfied.

One such additional condition for the switching of the lock 30 is derived from the circumstance that access to the vehicle is to be granted only to authorized persons, not to someone without such proper authorization. The authorized person carries an identification transmitter, referred to in the following in brief as an “ID transmitter”, for which a corresponding identification receiver, called in a similar manner the “ID receiver”, is provided in the vehicle. Normally, an ID transmitter of this type is passive. It works when the authorized person simply approaches the vehicle. There is no need for the person to perform any action on the ID transmitter or with the ID transmitter. It is also conceivable, however, that an active ID transmitter could be used, such as an electronic remote-control key, which, in order to become active, must be activated by a button. In both cases, one-way or two-way communication takes place with the ID receiver. If these communications are successful, the successful outcome is reported to the control unit 25, which also receives the additional condition required for switching. By way of the previously mentioned electrical or mechanical connection 26, the control unit then switches the lock 30 to its previously mentioned unlocked position. Then, when the handle 20 is actually moved in the direction of the arrow 23 in FIG. 1, the lock 30 releases the door 12. The door can be opened. For this reason, this second capacitive sensor 45 is to be called the “opening sensor”. This opening sensor is not an object of the present invention.

The previously mentioned first capacitive sensor 40 is made less sensitive than the opening sensor and is to be referred to in the following as the “main sensor”. The main sensor 40 acts only in coordination with the previously mentioned third sensor 50, which is to be called the “auxiliary sensor”. This auxiliary sensor 50 has a piezoelectric element 51 as its sensor element, which responds to mechanical pressure. The piezoelectric element 51 is located above the electrode 41 of the main sensor 40. As FIG. 3 illustrates, the electrode 41 can even be the support surface for the piezoelectric element 51 and can itself be mounted on a small circuit board 35. The conductive pathways in the circuit board 35 can contain the electrical connections for the piezoelectric element 51 and the electrode 41 indicated in FIG. 1 at 52 and 48; this also applies to the analogous electrical connection 49 of the electrode 46 of the opening sensor 45. The circuit board 35 also serves as a carrier for the various electrical evaluation units 42 of the three sensors 40, 50, 45.

As can be seen the most clearly in FIG. 3, the handle 20 has a resilient wall at 28, which is designed to be touched and which therefore is to be called the “actuating point” of the main and auxiliary sensors 40, 50. So that pressure can be effectively exerted, a stud 29, which is intended to exert force effectively on the piezoelectric element 51 located underneath, can be provided on the inside surface of this actuating point 28. The piezoelectric element 51 and the electrode 41 can form a preassembled unit and thus be mounted jointly on the circuit board 35. Thus the electrode 41 can have laterally bent edges 34, as indicated in dash-dot line in FIG. 3. These edges 34 of the electrode grip the piezoelectric element 51 supported on the electrode 41 and thus hold it in position.

Because the main sensor 40 and the auxiliary sensor 50 are located at the same actuating point 28, they are both situated in the area with which the finger 27 shown in FIG. 3 makes contact when the handle 20 is gripped. Because of its long-distance capacitance sensitivity, the main sensor 40 becomes active upon the mere approach of the finger but certainly no later than the time at which the finger makes actual contact with the actuating point 28. Then the main and auxiliary sensors transmit their own independent signals to their control and evaluation units 42, but the two signals are evaluated jointly. Only if the evaluation units 42 find both signals to be correct is an output signal 43 generated, which, as previously mentioned, is sent to the control unit 25. In the event of a successful evaluation, the control unit 25 switches the lock 30 to its locked position, as previously described.

When the actuating point 28 is contacted, the piezoelectric element 51 of the auxiliary sensor 50 transmits only a short power-on signal. The duration of this contact is not detected. The duration of the contact, however, is determined by the capacitive main sensor 40 and results in a corresponding modification of the output signal 43. As a function of the contact duration, it is then possible, in addition to the previously mentioned switching of the lock 30, to initiate one or more other functions in the vehicle. The initiation of so-called “convenience” functions by which certain movable parts in the vehicle are moved is especially advantageous. The types of convenience functions which can be initiated have already been mentioned by way of example above.

### LIST OF REFERENCE NUMBERS

10 device, closing device
11 bracket
12 door
13 exterior panel of 12
14 pivot bearing of 20 on 11
15 opening in 11 for 22
16 opening in 11 for a lock cylinder
17 cover piece of 11
18 electric line for 43 in 20
19 electric cable for 43
20 handle
21 first end of 20
22 second end of 20
23 arrow of the pivoting movement of 20, actuation
24 interior of 20
25 control unit
26 electrical connection
27 human finger (FIG. 3)
28 resilient wall of 20, actuating point
29 stud at 28 for 51 (FIG. 3)
30 lock
31 mechanical input element of 30, lock element
32 electrical input of 30
33 arrow of the carry-along movement of 31
34 edge of 41 (FIG. 3)
35 circuit board in 24 (FIG. 3)
40 first sensor for the locking of 30, main sensor
41 electrode of 40
42 electrical components, evaluation units for 40, 50, 45
43 arrow of an electrical output signal of 42 to 25 (FIG. 1)
45 second capacitive sensor for the unlocking of 30, opening sensor
46 electrode of 45
47 electrical field of 40 (FIG. 3)
48 electrical connection of 41 to 42
49 electrical connection of 46 to 42
50 auxiliary sensor
51 piezoelectric element of 50
52 electrical connection of 51 to 42

1. Arrangement for actuating an electrical or electromechanical closing device (10) on a door (12) and/or a hatch of a vehicle,
with a handle (20), which is used to open and/or to close a lock (30) provided on the door (12) and/or hatch,
with at least two sensors, which, upon approach or contact, transmit separate signals, the signals nevertheless being evaluated (42) jointly, with the result that
the lock (30) is switched between an unlocked position and a locked position,
where, in the unlocked position, the actuation of the handle (20) is functionally effective for the lock (30) but is not functionally effective in the locked position,
wherein
a capacitive main sensor (40) and an auxiliary sensor (50) equipped with a piezoelectric element (51) are arranged one on top of the other at a common actuating point; in that
the common actuating point consists of an elastically resilient wall (28), which, when contacted, exerts pressure on the piezoelectric element (51); and in that
a successful evaluation (43) of the signals coming from the main and auxiliary sensors (40, 50) switches the clock (30) to its locking position.

2. Arrangement according to claim 1, wherein, when contact is made with the actuating point (28), the piezoelectric element (51) of the auxiliary sensor (50) transmits a short power-on signal without registering the duration of the contact; wherein
the duration of the contact, however, is determined by the main sensor (40); and in that
the main sensor (40) initiates not only the switching of the lock (30) but also, as a function of the duration of contact, one or more additional functions in the vehicle.

3. Arrangement according to claim 2, wherein the additional functions in the vehicle are convenience functions involving movable parts in the vehicle.

4. Arrangement according to claim 3, wherein the convenience functions consist in that at least one opened window in the vehicle is closed and/or an alarm system is turned on and/or a roof panel in the vehicle is closed and/or the side mirrors of the vehicle are retracted.

5. Arrangement according to claim 1, wherein at least one capacitive electrode (41) of the main sensor (40), the piezoelectric element (51) of the auxiliary sensor (50), and the resilient actuating point (28) are situated in or on the handle (20) of the closing device (10).

6. Arrangement according to claim 1, wherein, in addition to the main and auxiliary sensors (40, 50) serving to lock the lock (30), an opening sensor (45) is also provided, which switches the lock (30) to its unlocked position upon approach or contact.

7. Arrangement according to claim 6, wherein the opening sensor (45) is located in the handle (20).

8. Arrangement according to claim 5, wherein at least one electrical component (42) for operations, for control, and/or for evaluation of the signals from the main and/or auxiliary sensor (40, 50) and the signals coming from the opening sensor (45) are located in the handle (20).

9. Arrangement according to claim 1, wherein the control unit (25) initiates the switching of the lock (30) between the locked position and the unlocked position only if the main and auxiliary sensors (40, 50) have been contacted by an authorized person.

10. Arrangement according to claim 9, wherein the authorized person carries an active or passive identification transmitter (ID transmitter) on his/her person; in that
the ID transmitter communicates with an identification receiver (ID receiver) in the vehicle; and in that
if the communication between the ID transmitter and the ID receiver is successful, the device (10) is released for actuation (23).
